(19) United States
(12) Patent Application Publication
(10) Pub. No.: US 2003/0054767 A1
(43) Pub. Date: Mar. 20, 2003

(54) Method and apparatus for using wireless network enabled devices over existing wired telephone networks

(76) Inventors: Indur B. Mandhyan, Princeton, NJ (US); Zygmond Turski, Florence, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(21) Appl. No.: 10/218,470

(22) Filed: Aug. 14, 2002

Related U.S. Application Data
(60) Provisional application No. 60/312,253, filed on Aug. 14, 2001.

(51) Int. Cl. H04B 1/38

(52) U.S. Cl. 455/41; 455/555; 455/554

(57) ABSTRACT

A method and apparatus for expanding a mobile wireless telephony with minimal changes or modifications to an existing and installed wire-line telephony infrastructure that comprises a wireless base station that periodically transmits a wireless signal to initiate and maintain a wireless network. The wireless base station couples a wired signal to a wired telephone network. At least one RF enabled device is responsive to the wireless signal from the wireless base station to form the wireless network and provide the wired signal for coupling to the wired telephone network.

### CROSS-REFERENCE TO RELATED APPLICATIONS

This application claims benefit of United States provisional patent application serial No. 60/312,253, filed Aug. 14, 2001, which is herein incorporated by reference.

### BACKGROUND OF THE INVENTION

1. Field of the Invention

The present invention generally relates to wireless communication systems and, more particularly, to a method and apparatus for using wireless network enabled devices to communicate over existing wired telephone networks.

2. Description of the Related Art

A wireless network generally comprises one or more base stations that each communicates with a plurality of radio frequency (RF) communications devices. In general, RF communication devices that are used in wireless local area networks have limited range and fidelity. In order to cover a large area with a wireless network of RF communications devices, additional radio frequency base stations must be added to the network. In addition, a network may also include intermediate stations that communicate with the RF devices, the multiple base stations, and other intermediate stations. Increasing the coverage area of an RF system can be, due to additional equipment costs, very expensive and complicated.

In general, wireless communications devices use high-frequency signals: 900 MHz to 1900 MHz for cellular phones and higher (up to 6 GHz) for other systems, such as wireless LANs. There are several wireless communications standards either in existence or being proposed, such as for example, Home RF, IEEE 802.11, and the like. For example, the “BLUETOOTH” standard is a short-range wireless communication standard that has many uses for voice applications and telephony (e.g. cordless phone, wireless headsets) and also for data applications (laptop to personal computer communication, wireless local area network gateways, and the like.). The BLUETOOTH wireless technology is implemented using a universal radio interface in the 2.45 GHz frequency band that enables portable electronic devices to connect and communicate wirelessly via short-range (e.g., about 10 meters, 100 meters; or 300 meters), ad hoc networks. To increase the geographic area covered by a BLUETOOTH network, additional base stations must be added to the network.

Therefore, there is a need in the art for a method and apparatus that provides simple and robust expansion of a wireless network.

### SUMMARY OF THE INVENTION

The present invention is a method and apparatus for enhancing the data transmission capacity of a wireless communication network or system while providing connectivity flexibility to mobile network users. The invention provides mobile wireless telephony with minimal changes or modifications to existing and installed wire-line telephony infrastructure. In one embodiment of the invention, the apparatus enables a user to move from place to place and, when the user moves close to a base station within a new location, the invention connects the user to that base station. As such, adding base stations, to a wired infrastructure, that can communicate to any of the RF devices and reconfigure the network, easily and flexibly expands the network.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a conventional landline phone connection;

FIG. 2 depicts a block diagram showing one embodiment of the invention, connected to a plurality of RF enabled devices;

FIG. 3 depicts a block diagram showing one embodiment of the invention, connected to a private branch exchange;

FIG. 4 depicts a block diagram showing one embodiment of the present invention as used throughout a location-to-location communication system, e.g., a campus-to-campus communication system;

FIG. 5 depicts a flow diagram of an embodiment of a method used in conjunction with the invention; and

FIGS. 6A-6C depict a flow diagram illustrating an embodiment, of an RF enabled device's association to a wireless base station, used in conjunction with the invention.

### DETAILED DESCRIPTION

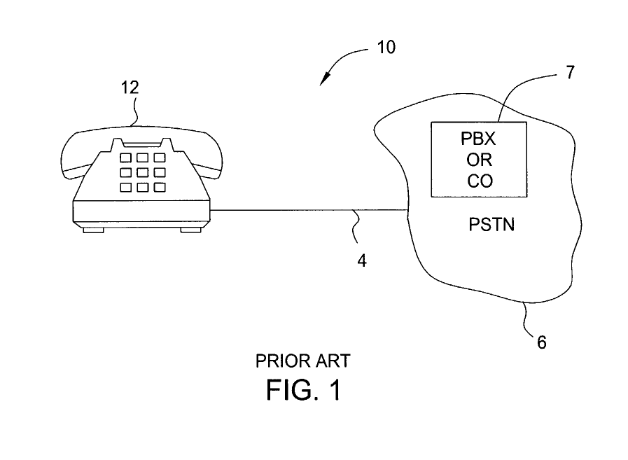

FIG. 1 depicts a conventional telephone network 10 having a wired telephone 12 connected via telephone line 4 to a public switch telephone network (“PSTN”) 6 or other telephony infrastructure components. The telephone 12 connects via line 4 to a desktop or wall-mounted unit. Telephone line 4 may interconnect the wired phone 12 to the PSTN 6 through various interfaces. For example, both ends of the telephone line 4 may conform to the RJ-11 standard (not shown). A desktop or wall-mounted telephone 12 connects to the PSTN 6 via an RJ-11 termination or socket (one on the telephone and one on the wall). This general infrastructure is available virtually everywhere, i.e., on most desks and in most offices. The telephony infrastructure used by the PSTN 6 may include a PBX or a central office (“CO”) 7 and offer services such as voice mail and other interactive voice response (“IVR”) applications.

For illustrative purposes only, the BLUETOOTH standard will be described herein, however, one skilled in the art will appreciate that other wireless network standards may be used in conjunction with the invention.

BLUETOOTH is designed to operate in a noisy radio frequency environment. A BLUETOOTH radio module/device uses a fast acknowledgment and frequency hopping technique to form a robust link between a base station and a user or client device. BLUETOOTH radio modules avoid interference from other signals by hopping to a new frequency after transmitting or receiving a packet from the wireless network. The BLUETOOTH standard implies wireless connectivity to base station(s) within a specified range using a gross bandwidth of 1 Mbps. The specified range of the BLUETOOTH standard may include, but is not limited to, ranges of about 10-300 meters. BLUETOOTH can support an asynchronous data channel, up to three simultaneous synchronous voice channels, or a channel that simultaneously supports asynchronous data and synchronous voice.

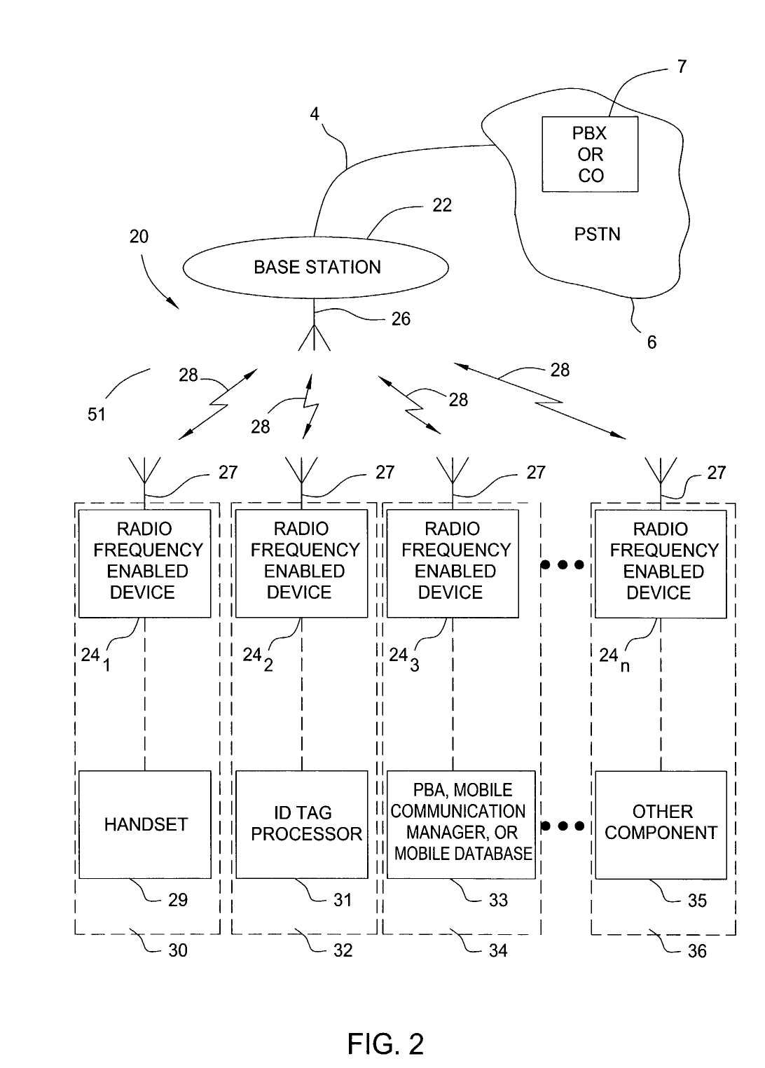

FIG. 2 depicts a block diagram showing one embodiment of the present invention. In particular, a wireless network 20 comprises a radio enabled base station 22 and at least one radio frequency (RF) enabled device 24. The base station 22 is electrically connected, via a telephone line 4 to a PSTN 6 or other telephony infrastructure such as a PBX or CO 7. The base station 22 establishes communication paths 28 with at least one RF enabled device 24 via antennae 26 and 27, respectively. Simply stated, in one embodiment of the present invention, the telephone 12 of FIG. 1 is replaced with the base station 22 and RF enabled device 24. In another embodiment, the capabilities of base station 22 are incorporated into a telephone 12. In yet another embodiment, base station 22 is connected in parallel with a telephone 12.

In one embodiment, the RF enabled device 24, is coupled to a handset 29 forming an RF enabled handset application 30. In another embodiment, the RF enabled device 24₂ is coupled to an identification tag circuit forming an RF enabled ID tag application 32. In still another embodiment, the RF enabled device 24₃ is coupled to a personal data assistant (“PDA”), mobile communication manager, or mobile data base manager 33 forming an RF enabled PDA application, RF enabled mobile communication manager application, or RF enabled mobile database manager application 34, respectively. Other applications 31 can be established by coupling various communications or computer devices (other components 35) to an RF enabled device 24.

Associated with the BLUETOOTH standard are various profiles, e.g., a telephony profile. For brevity and for illustrative purposes only, the invention is described herein in conjunction with the telephony profile and not intended in any way to limit the scope of the invention. In addition, one skilled in the art will appreciate that other BLUETOOTH profiles may be used with the invention described herein. The RF enabled device 24 and base station 22 are configured to use the same profile(s). In one embodiment, the RF enabled device 24 and base station 22 use one profile.

In another embodiment, an RF enabled device 24 is configured to use multiple profiles and communicates with a base station 22 configured to use the same profiles, e.g., an RF device 24 configured to use two profiles communicates with a base station configured to use the same two profiles.

FIG. 2 also depicts a BLUETOOTH piconet 51. As is known in the art, a BLUETOOTH device (such as RF enabled device 24) in communication with a base station 22 forms a piconet 52. Although FIG. 2 depicts more than one RF enabled device (elements 24₁-24ₙ) one skilled in the art will appreciate that a single RF enabled device 24 and base station 22 define the simplest form of the piconet 52. A piconet is generally defined as a collection of devices connected via BLUETOOTH technology in an ad hoc fashion. All RF devices used in a BLUETOOTH environment are peer units and have identical implementations. Each unit has its own unique 48-bit address referred to as the BLUETOOTH device address. However, when establishing a piconet, one unit will act as a master and the other(s) as slave(s) for the duration of the piconet connection (discussed in greater detail below).

The base station 22 may be powered by DC voltage from the PBX or CO switch 7 that are generally part of the PSTN 6. The base station 22 is uniquely identified by a BLUETOOTH device number (assigned by the Institute of Electrical and Electronic Engineers (“IEEE”)). This unique device number is associated with the device number of a RF enabled device 24₁-24ₙ. The base station 22 uses a unique telephone number (assigned by the telephone company) to connect to the voice network of the PSTN 6. The base station 22 incorporates hardware & software for interfacing with the RF device(s) in the network and with the PSTN 6.

The RF enabled device 24 may be any type of devices that satisfy BLUETOOTH requirements, for example, in one embodiment device 24 may be a handset and in another embodiment an identification (“ID”) tag. If a standard other than BLUETOOTH is used, the RF device 24₁-24ₙ must be compatible with the appropriate standard used by the base station 22.

The RF enabled device 24 may support a variety of BLUETOOTH applications, e.g., the RF enabled handset application 30 may support a telephony profile in one embodiment; the Logical Link Control and Adaption Protocol (“L2CAP”) layer in another embodiment; and in yet another embodiment, the telephony profile and the L2CAP layer. The RF enabled handset application 30 incorporates hardware & software for voice coding and decoding; and for establishing synchronous and asynchronous connections to base station 22 and initiating and receiving calls. The RF enabled handset application 30 is powered by a battery within the RF enabled handset application 30. The RF enabled handset application 30 is uniquely identified by a BLUETOOTH device number (assigned by IEEE) and by a home phone number (assigned by the telephone company and explained in greater detail below). This unique device identifier is associated with a (unique) home base station 22. The invention provides mobile wireless telephony with minimal changes or modifications to existing and installed wire-line telephony infrastructure. In one embodiment of the invention, the apparatus enables a user to move from location to location and, when the user moves close to a base station within a new location, the invention connects the user's apparatus to that base station. This increases substantially the range of the application.

In another embodiment, the base station 22 is configured to, when in physical contact with the RF enabled handset application 30, charge the battery and supply power to the RF enabled handset application 30.

In another illustrative embodiment, the BLUETOOTH application is an ID tag application 32. The ID tag application 32 comprises a RF enabled device 24 and ID tag circuitry 31 for processing ID tag related communications. An ID tag application 32 is a BLUETOOTH enabled device 24 that is coupled to an ID tag processor 31 and is tied to a home base station 22. A base station 22 that has the same phone number as an ID tag application is referred to as the home base station of the ID tag application 32. The ID tag application 32 is associated with a user (e.g., a corporate ID card) and allows one to ascertain the location of the user via the ID tag application 32. The ID tag application 32 may, for example, be within an identity badge.

The ID tag circuitry 31 comprises, in one embodiment, a battery, read only memory (“ROM”), and a microprocessor.

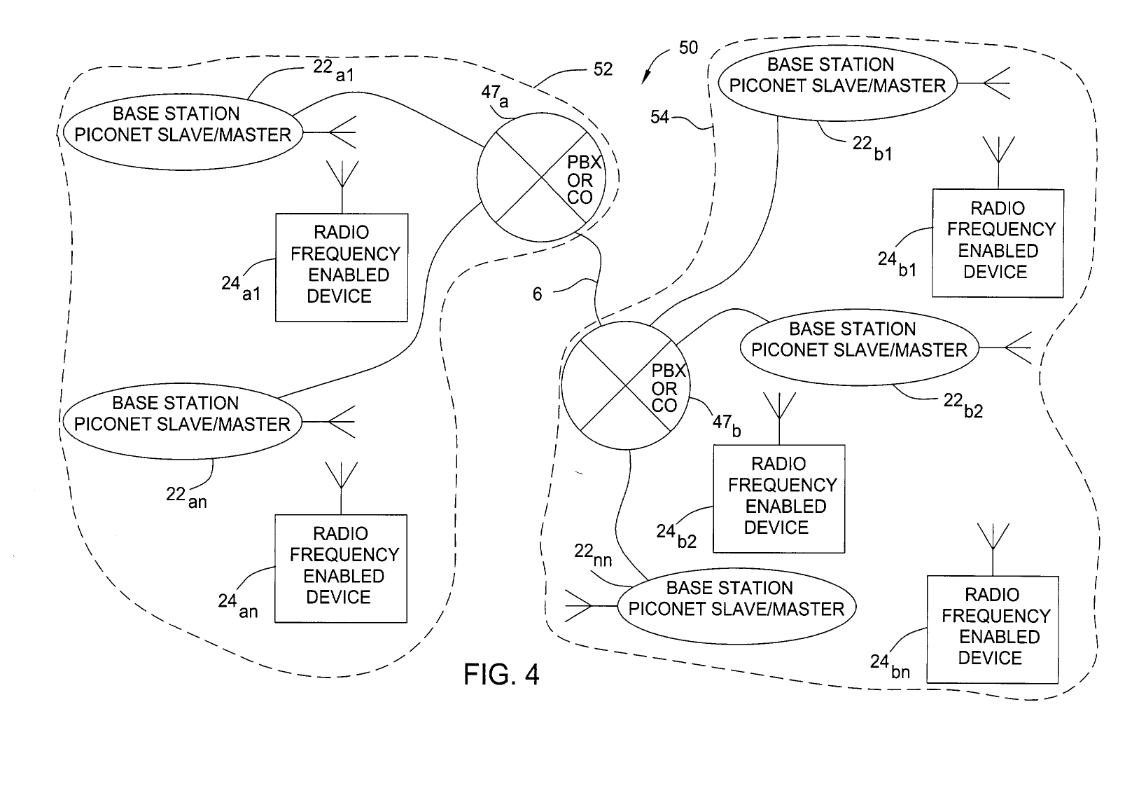

In accordance with one embodiment of the invention, calls may be forwarded to a user based upon the location of an ID tag application 32 associated with the user. When an ID tag application 32 comes within the range of another base station becomes a member of that base station's network if that base station has a greater signal strength. This base station is referred to as a remote base station (home/remote base stations are explained in detail below with reference to FIG. 4). The remote base station instructs the PBX or CO switch 7 via the call forwarding feature of the PBX or CO switch 7 to forward all calls made to the home base stations associated with the current members (the ID tag application 32) of the network to the remote base station. Any and every call intended for the (home) base station 22 is forwarded to the remote base station 22 that currently has the ID tag application of the home base station as a member of its network. The remote base station takes incoming calls. The call is answered by anyone in the vicinity of the handset and handed to the appropriate recipient (some ID tag owner) of the call. Note that in this scenario there may not be an RF enabled handset application 30.

Although the ID tag application 32 is described herein in conjunction with a corporate ID tag, the description is not intended in any way to limit the scope of the invention. Further, the ID tag application 32 may be placed within/on any item requiring that its location be kept track of.

In another embodiment, the invention can be modified, as discussed later with reference to FIG. 4, to bypass the call forwarding feature of a PBX 7 by causing a remote base station to communicate directly with the home base station thereby providing its identity to the home base station. The home base station routes all incoming calls to the remote base station.

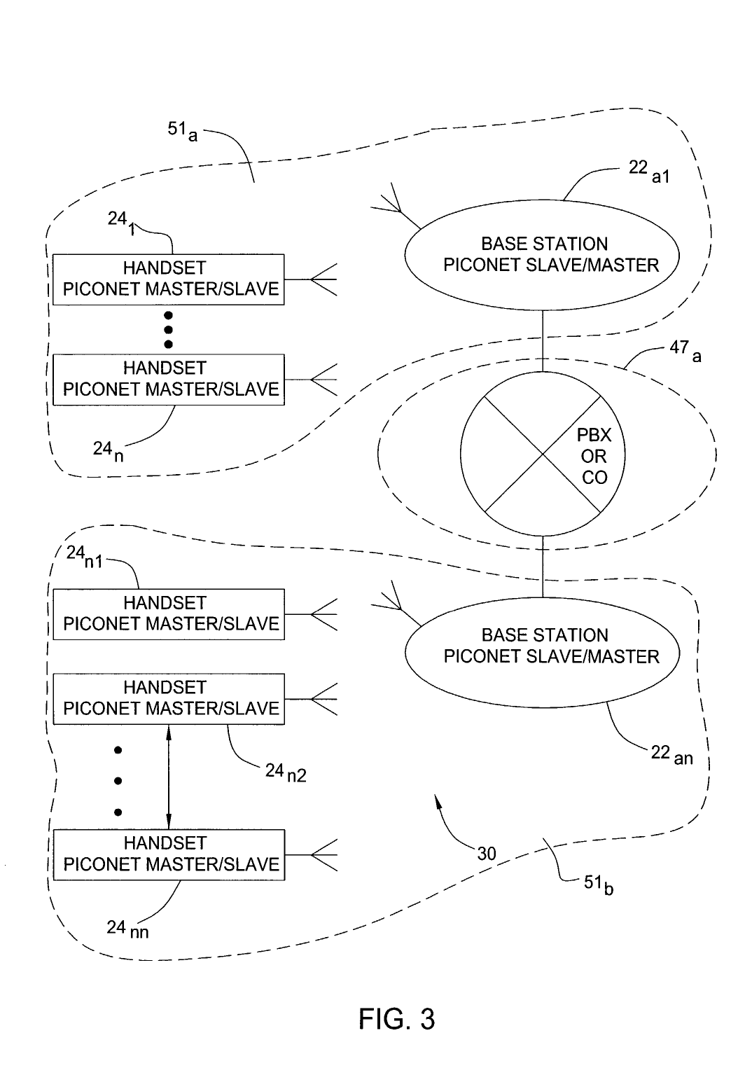

FIG. 3 depicts a block diagram showing one embodiment of the invention, connected to the PBX 47ₐ. Although FIG. 3 depicts element 24 as a handset, one skilled in the art will appreciate that this is one example of an RF enabled device and is not intended in any way to limit the scope of the invention. The PBX 47ₐ is connected, via wired telephone lines, to the base stations 22ₐ₁ and 22ₐₙ. The base stations 22ₐ₁ and 22ₐₙ are in wireless communication with handsets 24₁₁-24₁ₙ and 24ₙ₁-24ₙₙ, respectively.

One handset 24 may communicate with another handset within its piconet; to another handset within another piconet; or move within proximity of a base station of a second piconet and become part of the second piconet. For example, handset 24₁₁ may communicate, via base station 22₁ to another handset 24₁ₙ within its piconet 51ₐ; handset 24₁₁ may communicate via base station 22₁, PBX 47ₐ, and base station 22ₙ, to handset 24ₙ₁; and handset 24₁₁ may move within close proximity of base station 22ₙ and in one embodiment become part of piconet 51_{b}. When handset 24₁₁ moves within close proximity of base station 22ₙ the handset 24₁₁ determines whether base station 22ₙ has a stronger signal than base station 22₁. The handset 24₁₁ switches from piconet 51ₐ to piconet 51_{b} if base station 22ₙ has the stronger signal. In another embodiment, the handset 24₁₁ remains within piconet 51ₐ and will not handoff from base station 22₁ to 22ₙ during a transmission session. Close proximity as used herein is defined as the transmission range within which a base station 22 can accurately communicate with a handset 24.

Although FIG. 3 depicts base stations 22₁ and 22ₙ, one skilled in the art will appreciate that the invention allows the connection of additional base stations 22 thereby expanding the usage area of an RF device 24. Further, FIG. 3 depicts the base stations 22₁-22ₙ having master/slave relationships (discussed in greater detail below) with the handsets 24₁-24ₙ within their respective piconet. In addition, other embodiments have various combinations of features that may include, but are not limited to: CO (not shown) rather than a PBX 47ₐ;an ID tag (not shown) rather than or in combination with a handset 24; and an ID tag (not shown) rather than or in combination with a PDA (not shown).

FIG. 4 depicts a block diagram showing one embodiment of the present invention as used throughout a location-to-location communication system, e.g., a campus-to-campus communication system. In particular, a first location 52 has, contained therein, a PBX 47a with base stations 22ₐ₁-22ₐₙ wired thereto. A second location 54 has a PBX 47b with base stations 22_{b1}-22_{bn} wired thereto. Each of the respective base stations 22ₐ₁-22ₐₙ and 22_{b1}-22_{bn} is in communication with RF enabled devices 24ₐ₁-24ₐₙ and 24_{b1}-24_{bn}. PBX 47ₐ and PBX 47_{b} are connected to one another through the PSTN 6. An RF enabled device 24 can move throughout location 52 and location 54 and be in communication with the wireless network 50. For example, RF device 24ₐ₁ may move within close proximity to the base station 22_{b1}. In one embodiment, RF device will become part of the piconet associated with the base station 22_{b1}. Signals (e.g., a phone call) intended for RF device 24 will be forwarded to the base station 22_{b1} Simply adding more base stations 22 expands the wireless network 50.

A device is in master mode when it requests an action or a service on a piconet; or when that device's clock and hopping sequence are used to synchronize all other devices in the piconet. After the action or service request, the device switches from master mode to slave mode and upon receipt of the action or service request the base station switches from slave mode to master mode. There can only be one device at a time that is in master mode in a piconet. Any device in a piconet that is not in master mode is in slave mode. The handset 24 is in master mode when it initiates a phone call and in slave mode when it is on the call accepting side. The base station 22 is in slave mode when it is on the call originating side and in master mode when on the call accepting side. A base station registers all handsets 24₁-24ₙ within its transmission range. This establishes a piconet that is uniquely identified and determined by the identity of the base station. The base station that determines the identity of the piconet is referred to as the remote base station.

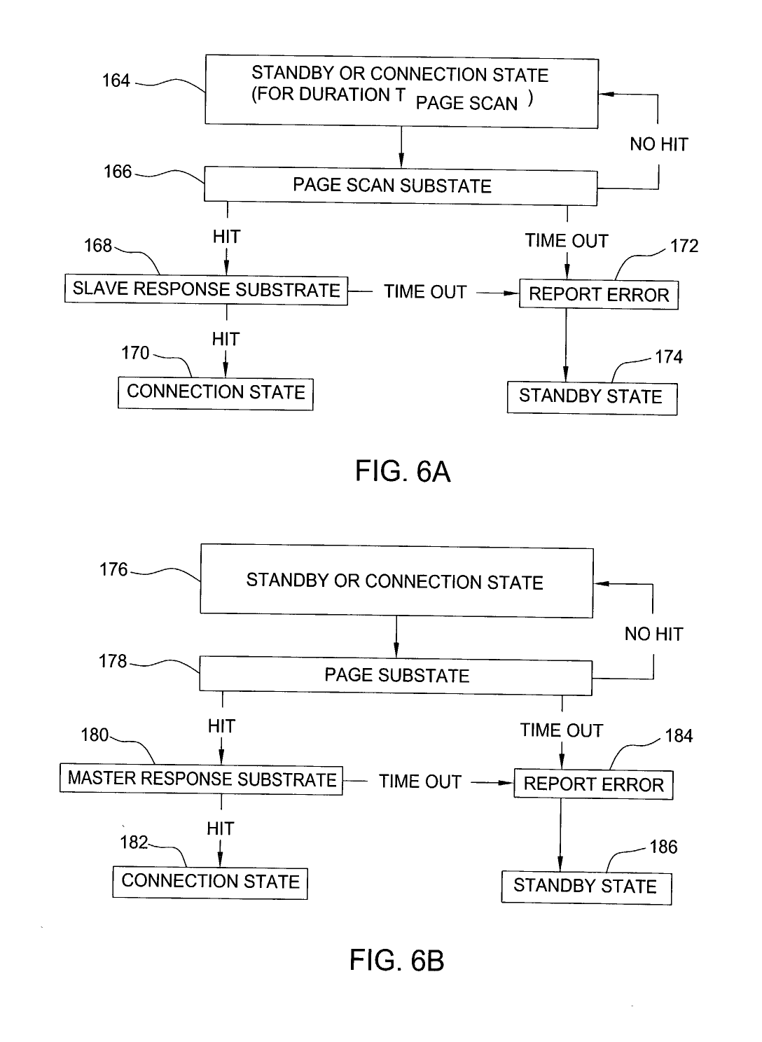

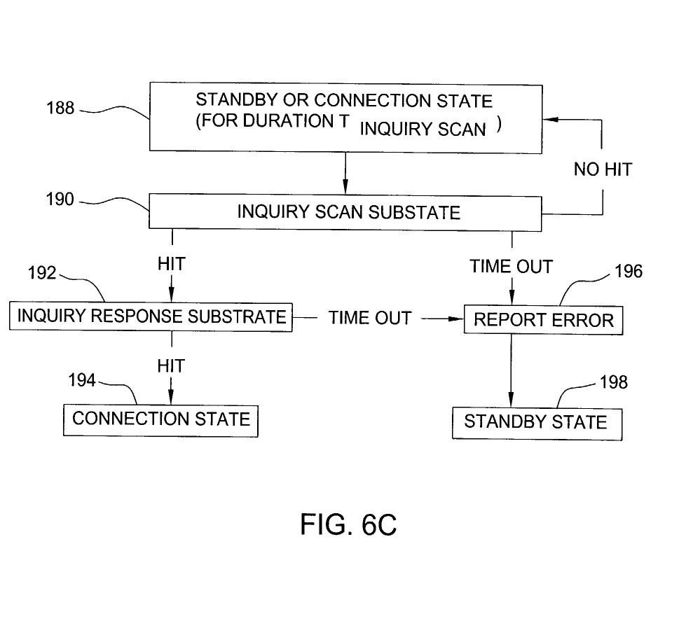

With respect to establishing network connections, before any connections in a piconet are created, all devices are in STANDBY mode. In this mode, an unconnected unit periodically “listens” for messages every 1.28 seconds. Each time a device wakes up, it listens on a set of hop frequencies defined for that unit. The number of hop frequencies varies in different geographic regions; 32 is the number for most countries (except Japan, Spain and France where it is currently limited to 16). The connection procedure, as defined by the BLUETOOTH standard, is initiated by any of the devices which then enters the master mode. A connection is made by a PAGE message if the address of the RF enabled device 24 is already known, or by an INQUIRY message followed by a subsequent PAGE message if the address is unknown (a PAGE message and an INQUIRY message will be defined below with reference to FIGS. 6A-6C).

In the initial PAGE state, the device in master mode will send a train of 16 identical page messages on 16 different hop frequencies defined for the device to be paged (slave unit). If there is no response, the device in master mode transmits a train on the remaining 16 hop frequencies in the wake-up sequence.

The RF enabled handset application 30ₐ, (shown in FIG. 2) in order to initiate a call, enters master mode, in its piconet, by initiating a make call protocol. The make call protocol transfers the necessary call parameters from the handset 29ₐ (shown in FIG. 2) to the base station 22ₐ (shown in FIG. 2). The RF enabled handset application 30ₐ (shown in FIG. 2) reverts to its slave mode. The base station 22ₐ (shown in FIG. 2) places the call and establishes a synchronous link between the RF enabled handset application 29ₐ (shown in FIG. 2) and base station 22ₐ (shown in FIG. 2). The RF enabled handset application 29ₐ (shown in FIG. 12) takes the call.

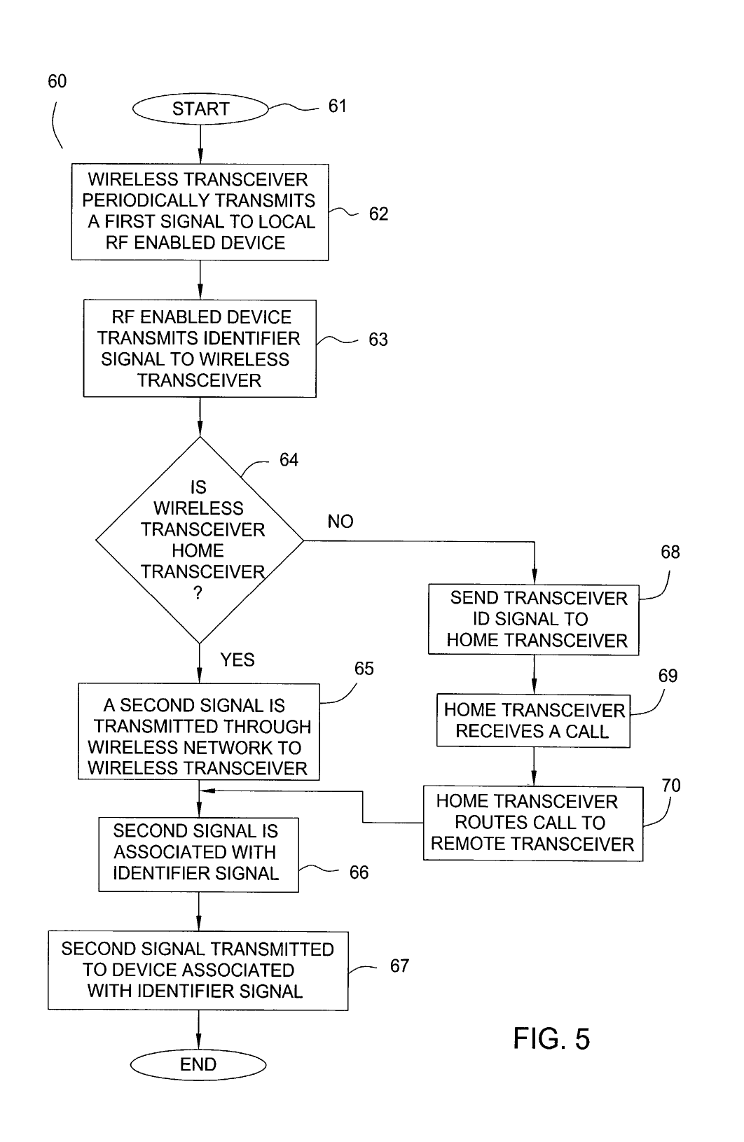

FIG. 5 depicts a flow diagram of an illustrative embodiment of a method 60 of operation of the invention. To best understand the invention, the reader should simultaneously refer to FIGS. 4 and 5. For illustrative purposes, wireless base station 22ₐ₁ is referred to as remote base station 22ₐ₁ and wireless base station 22_{bn} is referred to as a home base station 22_{bn}.

In particular, the method begins at step 61 and proceeds to step 62. At step 62, remote base station 22ₐ₁ periodically transmits the PAGE message (also known as a polling frequency or a “ping”) to an RF enabled device 24_{bn} within the transmission range of the remote base station 22ₐ₁. In response, the RF enabled device 24_{bn}, at step 62, transmits an identifier signal to the remote base station 22ₐ₁. At step 64, the remote base station 22ₐ₁ determines whether the RF enabled device 24_{bn} is a device that is recognized as having base station 22ₐ₁ as its home base station.

If, in step 64, remote base station 22ₐ₁ recognizes the signal transmitted from the device 24_{bn} as identifying a device that has base station 22ₐ₁ as its home base station, then at step 65 a subsequent signal (e.g., a phone call) is transmitted, through the wired telephone 4, directly to the base station 22ₐ₁. The base station 22ₐ₁, at step 66, determines which device 22 in the piconet 51 the signal is to be routed and routes the signal, at step 67, accordingly. The method ends at step 71

If, at step 64, the remote base station 22ₐ₁ does not recognize the signal from device 24_{bn} as belonging to a device having remote base station 22ₐ₁ as its home base station 22 then the remote base station 22ₐ₁ sends information to the home base station 22_{bn} informing the home base station 22_{bn} of the association of device 24_{bn} within the piconet 51 of remote base station 22ₐ₁. At step 69, the home base station 22_{bn} receives a call and reroutes the call, at step 70, to remote base station 22ₐ₁. The remote base station 22ₐ₁, at step 66, determines which device 24 within its piconet 51 the signal should be sent to and subsequently transmits the signal, at step 67, to the appropriate device 24. The method ends at step 71.

In still another embodiment, the handset initiates the INQUIRY process to conserve the power of the base station and optimize bandwidth. For example, when a handset 24 enters a room already having at least one other handset, a user may press a button on the handset 24 to initiate the INQUIRY process. The baseband protocol layer allows the base station to accept the inquiry and forward a call to a handset while the base station is in slave mode. The baseband is the physical layer of the BLUETOOTH. It manages physical channels and links apart from other services like error correction, data whitening, hop selection and BLUETOOTH security. The baseband layer lies on top of the BLUETOOTH radio layer in the BLUETOOTH stack. The baseband protocol is implemented as a Link Controller, which works with the link manager for carrying out link level routines like link connection and power control. The baseband also manages asynchronous and synchronous links, handles packets and does paging and inquiry to access and inquire BLUETOOTH devices in the area.

In another embodiment, the remote base station 22ₐ₁ sends information regarding the association of device 24_{bn} with the piconet 51 of remote base station 22ₐ₁ to PBX 47_{b}. When a signal is sent that is meant for device 24_{bn}, PBX 47_{b} routes the call to remote base station 22ₐ₁.

FIGS. 6A-6C depict a flow diagram illustrating an embodiment, of an RF enabled device's association to a wireless base station, used in conjunction with the invention. Under the BLUETOOTH standard, an unconnected device initially operates in “standby” mode. The connection procedure is initiated by any of the devices, which is then in master mode. The connecting states are PAGE and INQUIRY. A connection is made by a PAGE message if the address of the device is already known, or by an INQUIRY message followed by a subsequent PAGE message if the address is unknown.

A PAGE message is a message that a base station sends when searching for other devices. The device sends out a page packet (ID packet), using the page hopping sequence, to notify other devices that it wants to know about the other devices and/or their services. The inquiry procedure enables a device to discover which devices are in range, and determine the addresses and clocks for the devices. The inquiry procedure involve a unit (the source) sending out inquiry packets (inquire state) and then receiving the inquiry reply. The unit that receives the inquiry packets (the destination), will generally be in the inquiry scan state to receive the inquiry packets. The destination will then enter the inquiry response state and send an inquiry reply to the source. After the inquiry procedure has completed, a connection can be established using the paging procedure. When a device has received an inquiry packet, it can respond with an inquiry reply packet (an FHS packet). It will send this using the inquiry response hopping sequence.

Referring to FIG. 6A, the PAGE SCAN substate is initiated in state 166 by the device 24 which then becomes the device in master mode. The device is sending signals on various channels in the pre-defined initiation hop pattern looking for a base station with which to communicate. If a device in slave mode responds (a “hit”), the slave response substate 168 is entered. If there is no hit, the standby or connection state 164 is reentered. Once in state 168, if the slave responds before a timeout period, then the connected state 170 is entered. If the timeout period expires, however, an error is reported in state 172 and the standby state 174 is entered. An error is reported and logged internally.

FIG. 6B illustrates a page sequence. A connection state machine (“CSM”) within an RF enabled device begins in the standby or connection state 176 (for duration T.sub.page scan). The PAGE substate is initiated in state 178. If there is a hit, the master response substate 180 is entered. If there is no hit, the standby or connection state 176 is reentered. Once in state 180, if the master responds before a timeout period, then the connected state 182 is entered. If the timeout period expires, however, an error is reported in state 184 and the standby state 186 is entered.

FIG. 6C illustrates an inquiry scan sequence. The CSM begins in the standby or connection state 188 (for duration T inquiry scan). The INQUIRY SCAN substate is initiated in state 190. If there is a hit, the Inquiry response substate 192 is entered. If there is no hit, the standby or connection state 188 is reentered. Once in state 192, if the slave responds before a timeout period, then the connected state 194 is entered. If the timeout period expires, however, an error is reported in state 196 and the standby state 198 is entered. The inquiry sequence (not shown) subsequently begins. The CSM begins in the standby or connection state 200. The INQUIRY substate is initiated in state 202. If there is a hit, or a timeout, the status table is updated in state 204 and the previous connection or standby state is entered in state 206. If there is no hit, the standby or connection state 200 is reentered.

In another embodiment of the invention, a pay telephone may contain a base station or have base station capabilities built therein. An RF enabled device traveling within transmission range of the pay telephone will automatically have the calls sent to the payphone. In another embodiment, multiple users will be able to communicate, through their respective RF devices, using the RF transmissive pay telephone.

While the foregoing is directed to the preferred embodiment of the present invention, other and further embodiments of the invention may be devised without departing from the basic scope thereof, and the scope thereof is determined by the claims that follow.

1. An apparatus comprising:
a wireless base station periodically transmitting a wireless signal to initiate and maintain a wireless network and coupling a wired signal to a wired telephone network; and
at least one RF enabled device responsive to said wireless signal from said wireless base station to form said wireless network and providing said wired signal for coupling to the wired telephone network.

2. The apparatus according to claim 1, wherein said wireless base station communicates to at least one other wireless base station through a private branch exchange.

3. The apparatus according to claim 2, wherein said at least one RF enabled devices is coupled to at least one handset.

4. The apparatus according to claim 2, wherein said at least one RF enabled devices is coupled to at least one identification tag circuit.

5. The apparatus according to claim 1, wherein said wireless base station and said RF enabled device are BLUETOOTH compliant.

6. The apparatus according to claim 5, wherein said wireless network utilizes the BLUETOOTH telephone profile or the BLUETOOTH logical link and adaptation profile layer.

7. The apparatus according to claim 1, wherein said at least RF enabled device sends an identifying signal to said base station in response to said wireless signal.

8. The apparatus according to claim 1, wherein said at least one RF enabled device receives another wireless signal from another base station and determines which of said wireless signal from said base station or said another wireless signal from said another base station has a greater signal strength, wherein said RF enabled device becomes part of a network associated with said base station having said greater signal strength.

9. A method comprising:
transmitting a wireless signal, periodically, from a wireless base station to at least one RF enabled device to establish a network comprising said base station and said at least one RF enabled device;
communicating a wired signal between said base station and said at least one RF enabled device; and
communicating said wired signal between said wireless base station and a wired network.

10. The method according to claim 9, wherein said wired network is a telephone network.

11. The method according to claim 9, further comprising:
utilizing the BLUETOOTH standard to transmit between said base station and said at least one RF enabled device.

12. The method according to claim 11, further comprising:
utilizing the BLUETOOTH telephony profile or the BLUETOOTH logical link and adaptation profile layer.

13. The method according to claim 9, wherein said transmission through said wired telephone network comprises:
transmitting said wired signal through a private branch exchange to said base station; and
transmitting said response from said base station to said private branch exchange.

14. The method according to claim 10, wherein said at least one RF enabled device is coupled to at least one handset.

15. The method according to claim 10, wherein said at least one RF enabled device is coupled to at least one identification tag circuit.

16. A method comprising:
transmitting a wireless signal, periodically, from a wireless base station to at least one RF enabled device;
sending a device identifier signal from said at least one RF enabled device to said base station to establish a network comprising said wireless base station and said at least one RF enabled device; and
transmitting a wired signal to a remote location informing said remote location of said network.

17. The method according to claim 16, wherein said wired signal is transmitted to another wireless base station.

18. The method according to claim 16, wherein said wired signal is transmitted to a private branch exchange.

19. The method according to claim 16, wherein said at least one RF enabled device is coupled to an ID tag processor forming an ID tag application and said ID tag application is enabled to receive a wireless signal from another wireless base station and determine which of said wireless signal from said base station or said another wireless signal from said another base station has a greater signal strength, wherein said RF enabled device becomes part of a network associated with said base station having said greater signal strength.

20. The method according to claim 16 wherein said at least one RF enabled device is coupled to a headset and further comprises:
receiving another wireless signal, to said handset, from another wireless base station; and
determining which of said wireless signal from said base station or said another wireless signal from said another base station has a greater signal strength, wherein said RF enabled device becomes part of a network associated with said base station having said greater signal strength.
